(19) United States
(12) Patent Application Publication
(10) Pub. No.: US 2026/0070579 A1
(43) Pub. Date: Mar. 12, 2026

(54) APPARATUS AND METHOD FOR CONTROLLING AUTONOMOUS DRIVING OF A VEHICLE BASED ON COLLECTED TARGET DATA

(71) Applicants: Hyundai Motor Company, Seoul (KR); Kia Corporation, Seoul (KR)

(72) Inventor: Hyeong Gyu Kim, Hwaseong-Si (KR)

(21) Appl. No.: 19/080,027

(22) Filed: Mar. 14, 2025

(30) Foreign Application Priority Data
Sep. 11, 2024 (KR) 10-2024-0124128

(51) Int. Cl. B60W 60/00; G06N 20/00

(52) U.S. Cl. CPC B60W 60/001; G06N 20/00

(57) ABSTRACT

An apparatus for controlling autonomous driving of a vehicle is introduced. The apparatus may comprise at least one processor and a memory storing instructions. When executed by the at least one processor, the instructions are configured to cause the apparatus to receive target data information, wherein the target data information may comprise vectors of target data. The apparatus may obtain, using a pre-trained learning model, encoding vectors from pieces of input data, determine a vector similarity between the encoding vectors and the vectors of the target data, and determine, based on the vector similarity and a preset similarity threshold, the target data among the pieces of input data. Based on the determined target data, the apparatus may output a signal and control, based on the signal, autonomous driving of the vehicle.

### CROSS-REFERENCE TO RELATED APPLICATION

This application claims the benefit of priority to Korean Patent Application No. 10-2024-0124128, filed in the Korean Intellectual Property Office on Sep. 11, 2024, the entire contents of which are incorporated herein by reference.

### TECHNICAL FIELD

The present disclosure relates to a technology for collecting target data, and more particularly, relates to an apparatus and a method for collecting target data to collect the target data based on a vector similarity and controlling autonomous driving of a vehicle based on the target data.

### BACKGROUND

The matters described in this Background section are only for enhancement of understanding of the background of the disclosure, and should not be taken as acknowledgment that they correspond to prior art already known to those skilled in the art.

Machine learning refers to performing a prediction task, such as regression, classification, and clustering, based on contents the computer learns on its own based on data. For example, the machine learning may be applied to a technology for classifying a regular mail and a spam mail or recognizing a face of a user.

Meanwhile, such machine learning may be roughly divided into supervised learning and unsupervised learning. Because the supervised learning is to find a fixed answer by means of an algorithm, it is machine learning in the form of inferring a function from training data. A labeled sample is used for training in the supervised learning for such an inference process. Labeling refers to an output value to be targeted and the labeled sample refers to a sample to which a specific output value targeting prediction is input. A supervised learning algorithm receives a series of training data and a target output value corresponding to them, finds an error through learning for comparing an actual output value for input data and the target output value, and reflects the result in a learning model.

Meanwhile, a manual scheme and a scheme using an image processing program may be used for labeling of the training data for the supervised learning. Because the manual scheme may be able to accurately train the learning model, it may be more preferable than a method for using a label using a program or a machine. However, because a person directly labels a plurality of pieces of data, much time and high labor cost are required in the manual scheme.

### SUMMARY

According to the present disclosure, an apparatus for controlling autonomous driving of a vehicle, the apparatus may comprise at least one processor, and a memory storing instructions that, when executed by the at least one processor, are configured to cause the apparatus to receive target data information, wherein the target data information may comprise vectors of target data, obtain, using a pre-trained learning model, encoding vectors from pieces of input data, determine a vector similarity between the encoding vectors and the vectors of the target data, determine, based on the vector similarity and a preset similarity threshold, the target data among the pieces of input data, output, based on the determined target data, a signal, and control, based on the signal, autonomous driving of the vehicle.

The vectors of the target data comprise at least one of first vectors for obtaining rare data included in training data of the pre-trained learning model, wherein the rare data corresponds to data associated with images having lower average similarities than other images, second vectors for obtaining additional data which is not included in the training data, or third vectors for obtaining data for at least one preset target.

The instructions, when executed by the at least one processor, are configured to cause the apparatus to differently set a similarity threshold for each of the first vectors, and obtain, based on the vector similarity and the differently set similarity threshold of each of the first vectors, data corresponding to the first vectors among the pieces of input data.

The target data information indicates the first vectors and the second vectors, and wherein the target data information may comprise collection ratio information between the rare data and the additional data.

The instructions, when executed by the at least one processor, are configured to cause the apparatus to obtain, based on the vector similarity and the preset similarity threshold, pieces of collected data among the pieces of input data as the target data, and classify, based on the collection ratio information, the obtained pieces of collected data into the rare data and the additional data.

The instructions, when executed by the at least one processor, are configured to cause the apparatus to determine a vector similarity between the second vectors and the encoding vectors, determine a weighted mean of vector similarities by using an average similarity of each of the second vectors as a weight, and obtain input data as the additional data, wherein a weighted mean of vector similarities for the input data is smaller than the preset similarity threshold.

The instructions, when executed by the at least one processor, are configured to cause the apparatus to transmit the determined target data to a server at a preset transmission period.

According to the present disclosure, a method performed by an apparatus for controlling autonomous driving of a vehicle, the method may comprise receiving target data information, wherein the target data information may comprise vectors of the target data, obtaining, using a pre-trained learning model, encoding vectors from pieces of input data, determining a vector similarity between the encoding vectors and the vectors of the target data, determining, based on the vector similarity and a preset similarity threshold, the target data among the pieces of input data, outputting, based on the determined target data, a signal, and controlling, based on the signal, autonomous driving of the vehicle.

The vectors of the target data comprise at least one of first vectors for obtaining rare data included in training data of the pre-trained learning model, wherein the rare data corresponds to data associated with images having lower average similarities than other images, second vectors for obtaining additional data which is not included in the training data, or third vectors for obtaining data for at least one preset target.

The determining the target data may comprise differently setting a similarity threshold for each of the first vectors, and obtaining, based on the vector similarity and the differently set similarity threshold of each of the first vectors, data corresponding to the first vectors among the pieces of input data.

The method, wherein the target data information indicates the first vectors and the second vectors, and wherein the target data information may comprise collection ratio information between the rare data and the additional data.

The method, wherein the determining the target data may comprise obtaining, based on the vector similarity and the preset similarity threshold, pieces of collected data among the pieces of input data as the target data, and classifying, based on the collection ratio information, the obtained pieces of collected data into the rare data and the additional data.

The method, wherein the determining the target data may comprise determining a vector similarity between the second vectors and the encoding vectors, determining a weighted mean of vector similarities by using an average similarity of each of the second vectors as a weight, and obtaining input data as the additional data, wherein a weighted mean of vector similarities for the input data is smaller than the preset similarity threshold.

The method may further comprise transmitting the determined target data to a server at a preset transmission period.

According to the present disclosure, a system for controlling autonomous driving of at least one vehicle, the system may comprise a server configured to output, using a pre-trained learning model, encoding vectors of training data, extract vectors for obtaining target data from the encoding vectors, and transmit target data information, wherein the target data information may comprise the extracted vectors and predetermined target vectors, and a vehicle configured to receive the target data information from the server, determine, for pieces of obtained input data, a vector similarity between the predetermined target vectors and the encoding vectors, determine, based on the vector similarity and a preset similarity threshold, target data to be obtained by the server among the pieces of input data, transmit the determined target data to the server, output, based on the determined target data, a signal, and control, based on the signal, autonomous driving of the vehicle.

The system, wherein the predetermined target vectors comprise at least one of first vectors for obtaining rare data included in the training data, wherein the rare data corresponds to data associated with images having lower average similarities than other images, second vectors for obtaining additional data which is not included in the training data, or third vectors for obtaining data for at least one preset target, and wherein the server is configured to determine vector similarities among the encoding vectors of the training data to generate a vector similarity table, sort, based on an average similarity of each of the encoding vectors of the training data, the encoding vectors in an ascending order to extract a first predetermined number of encoding vectors with a highest average similarity as the first vectors, and sort, based on the average similarity, the encoding vectors in a descending to extract a second predetermined number of encoding vectors with a lowest average similarity as the second vectors.

The system, wherein the vehicle is configured to differently set a similarity threshold for each of the first vectors, and based on the vector similarity and the differently set thresholds for each of the first vectors, obtain data corresponding to the first vectors among the pieces of input data.

The system, wherein the target data information may comprise collection ratio information between the rare data and the additional data, and wherein the vehicle is configured to obtain, based on the vector similarity and the preset similarity threshold, pieces of collected data among the pieces of input data as the target data, and classify, based on the collection ratio information, the obtained pieces of collected data into the rare data and the additional data.

The system, wherein the vehicle is configured to determine a vector similarity between the second vectors and the encoding vectors, determine a weighted mean of vector similarities by using an average similarity of each of the second vectors as a weight, and obtain input data as the additional data, wherein a weighted mean of vector similarities for the input data is smaller than the preset similarity threshold.

The system, wherein the vehicle is configured to transmit the determined target data to the server at a preset transmission period.

The features briefly summarized above with respect to the present disclosure are merely examples of the detailed description of the present disclosure, which will be described below, and do not limit the scope of the present disclosure.

### BRIEF DESCRIPTION OF THE DRAWINGS

The above and other objects, features and advantages of the present disclosure will be more apparent from the following detailed description taken in conjunction with the accompanying drawings:

FIG. 1 shows an example of a system for collecting target data in the present disclosure;

FIG. 2 shows an example of a method for collecting target data according to an example of the present disclosure;

FIG. 3 shows an example of a configuration of a system for collecting target data according to another example of the present disclosure;

FIG. 4 shows an example of a process of transmitting target data information to each vehicle in a server;

FIG. 5A and FIG. 5B show an example of a process of extracting common image vectors and rare image vectors in a system of FIG. 3;

FIG. 6 shows an example of a process of collecting target data in a vehicle in a system of FIG. 3;

FIG. 7 shows an example of a configuration of a server illustrated in FIG. 1;

FIG. 8 shows an example of a configuration of a vehicle illustrated in FIG. 1; and

FIG. 9 shows an example of a computing system for executing a method for collecting target data according to an example of the present disclosure.

### DETAILED DESCRIPTION

Hereinafter, an example of the present disclosure will be described more fully with reference to the accompanying drawings to such an extent as to be easily embodied by one skilled in the art. However, the present disclosure may be embodied in many different forms and should not be construed as being limited to the example set forth herein.

In describing an example of the present disclosure, when it is determined that a detailed description of a well-known configuration or function may obscure the gist of the present disclosure, a detailed description thereof will be omitted. Parts not related to the description of the present disclosure are omitted in the drawings, and similar parts are denoted by similar reference numerals throughout the specification.

In the present disclosure, when one component is referred to as being “connected with” or “coupled to” another component, it includes not only a case where it is directly connected but also a case where it is indirectly connected with another component and there are other devices in between. In addition, when one component is referred to as “comprising”, “including” or “having” another component, it is meant that the component may further include other components without excluding other components as long as there is no contrary description.

In the present disclosure, the terms such as “first” and “second” are used only for the purpose of distinguishing one component from another, but do not limit an order, the importance, or the like of components unless specifically stated. Thus, a first component in an example may be referred to as a second component in another example in the scope of the present disclosure. Likewise, a second component in an example may be referred to as a first component in another example.

In the present disclosure, components which are distinguished from each other are only for clearly explaining each feature, and do not necessarily mean that the components are separated.

In other words, a plurality of components may be integrated to form a single hardware or software unit, or a single component may be distributed to form a plurality of hardware or software units. Thus, even if not specifically mentioned, the integrated or separate examples are also included in the scope of the present disclosure.

In the present disclosure, components described in various examples may not necessarily refer to essential components, some thereof may be selective components. Thus, an example composed of a subset of components described in an example is also included in the scope of the present disclosure. Thus, an example which additionally includes another component in components described in various examples is also included in the scope of the present disclosure.

In the present disclosure, expressions of positional relationships used in the specification, for example, top, bottom, left, and right, are described for convenience of description. When viewing the drawings shown in the specification in reverse, the positional relationship described in the specification may be interpreted in the opposite way.

In the present disclosure, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

Active learning is a method for repeating a process of selecting, labeling, and learning data to help to learn any collected dataset to gradually enhance network inference performance. There are two representative schemes to determine data to help to learn.

The first scheme may be a scheme for selecting data on the basis of the degree of inference inconsistency to a teacher model with good performance. The second scheme may be a scheme for modeling network inference uncertainty and selecting data, which may reduce cost required for data labeling because it is able to expect to achieve the same inference performance improvement with less datasets.

However, the first scheme has a limitation in selection from a vehicle collection stage in the way that inference of the teacher model uses many hardware resources and incurs additional communication cost between the vehicle and the server because it is only the way to first transmit an image to the server and operate the teacher model using resources of the server. The second scheme has an intrinsic limit in which incorrect inference with confidence is not prevented and has a limitation in applying a collection policy (e.g., data collection meeting a specific condition) because of using a numerical number for a probability distribution as a result of inference.

Examples of the present disclosure is the gist of providing a data collection pipeline using a vector similarity and easily collecting target data meeting a desired condition.

Examples of the present disclosure may include all types of data capable of being obtained from a vehicle, as well as image data. Collecting target image data is limited and described for convenience of description for an example of the present disclosure.

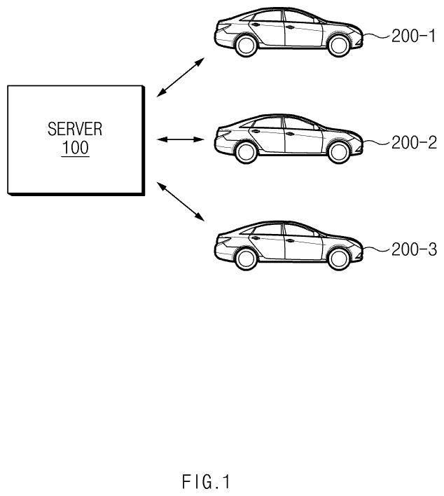

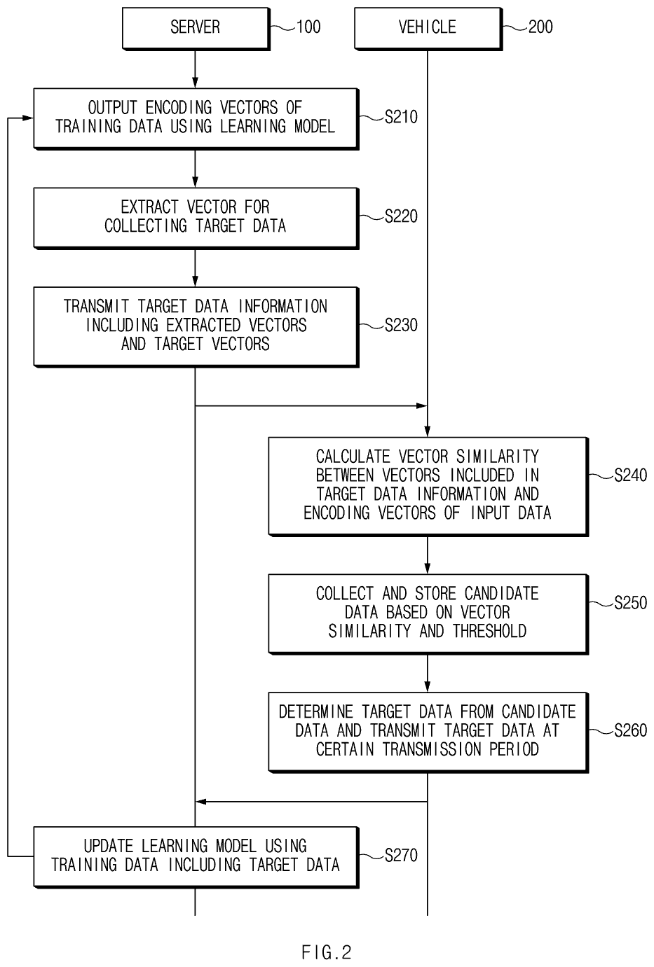

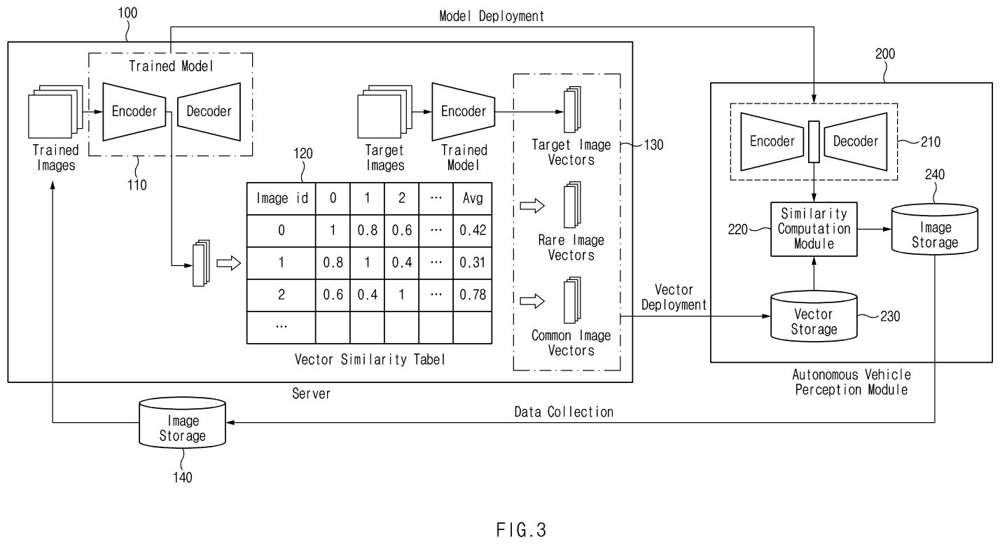

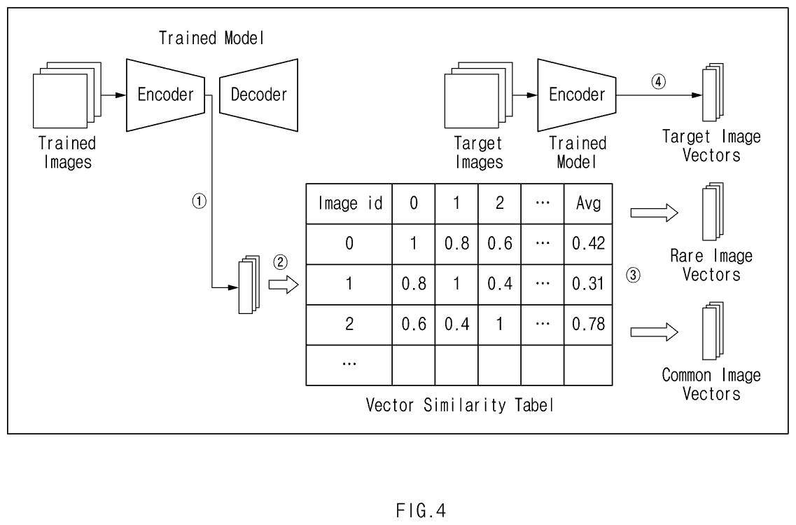

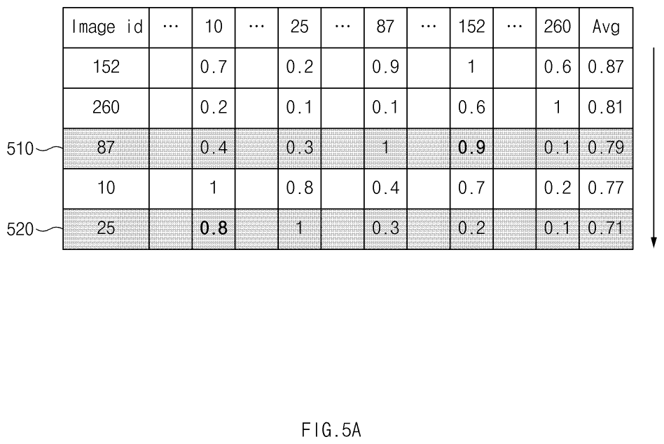

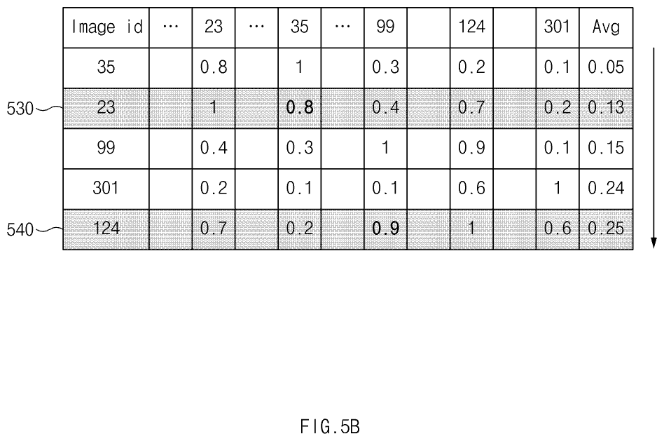

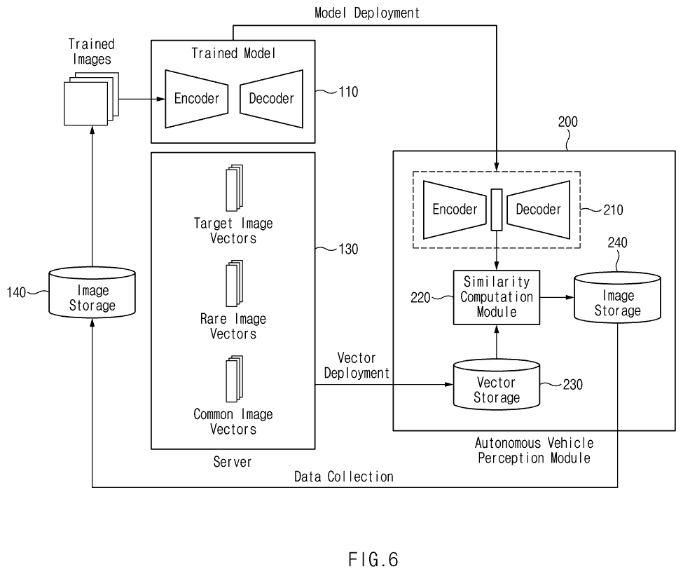

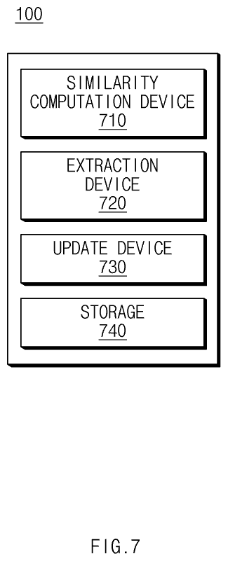

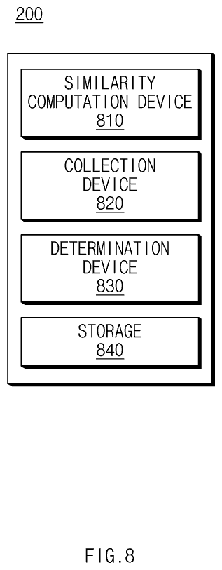

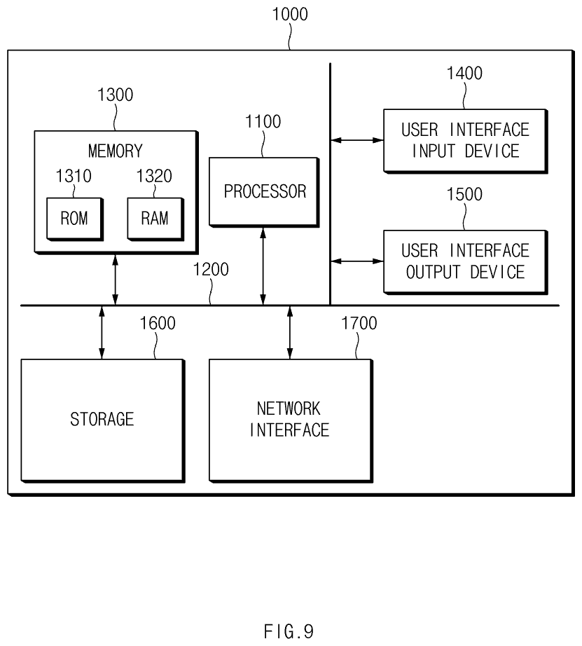

Hereinafter, a description will be given of an apparatus, a method, and a system for collecting target data according to an example of the present disclosure with reference to FIG. 1, FIG. 2, FIG. 3, FIG. 4, FIG. 5, FIG. 6, FIG. 7, FIG. 8, and FIG. 9.

According to the present disclosure, a more efficient data collection system for controlling autonomous driving of a vehicle using vector similarity and active learning is introduced. Relying on server-side processing, where all images collected by the vehicle are sent to servers for analysis, may lead to high communication costs and hardware resources. This system, however, may enable the vehicle to analyze and selectively save images on its own by comparing the encoded vectors of new images with predetermined vectors stored on the vehicle. By prioritizing images based on similarity thresholds and focusing on rare or challenging scenarios, the system may reduce redundant data collection and enhance the vehicle's ability to improve its performance over time.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on configured autonomous driving control setting(s) (e.g., based on at least one of: an autonomous driving classification, a selection of an autonomous driving level for a vehicle, etc.). Based on one or more features (e.g., features of target data based on vector similarities) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., features of target data based on vector similarities) described herein.

One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., features of target data based on vector similarities) described herein.

Minimum risk maneuver (MRM) operation(s) may also be controlled, for example, based on one or more features (e.g., features of target data based on vector similarities) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., features of target data based on vector similarities) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane. The driving control apparatus may identify or determine a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., features of target data based on vector similarities) described herein. An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

FIG. 1 shows an example of a system for collecting target data in the present disclosure.

As shown in FIG. 1, the system for collecting the target data according to an example of the present disclosure may include a server 100 and at least one vehicle (200-1, 200-2, and 200-3).

The server 100 may distribute a learning model trained by training data to each vehicle 200 and may distribute encoding vectors for collecting target data to each vehicle 200. In detail, the server 100 may output encoding vectors of training data, for example, training image data using the learning model, may extract image vectors for collecting the target data from the encoding vectors, and may distribute or transmit target data information including the extracted image vectors and predetermined target image vectors to each vehicle 200.

Herein, the target data information may include at least one of first image vectors for collecting rare image data included in the training data, second image vectors for collecting additional image data which is not included in the training data, or third image vectors for collecting data for at least one preset target image. The second image vectors may refer to encoding vectors for common image data or main image data, which is most occupied in the training data.

According to an example, the server 100 may extract the first image vectors and the second image vectors by comparing a vector similarity between the respective encoding vectors included in the training data, may determine (or calculate) an average vector similarity of each of the extracted image vectors, and may include the determined average vector similarity and collection ratio information for collecting the rare image data and the additional image data in the target data information to distribute or transmit the target data information to each vehicle 200.

The rare image data may refer to image data representing infrequent or underrepresented scenarios in a dataset, such as unusual weather conditions or rare traffic situations. It is identified using vector similarity metrics, where images with low average similarity to other data points may be classified as rare. These images are useful for improving machine learning models by enhancing their ability to handle edge cases and diverse situations. The collection of rare image data may be prioritized by dynamically adjusting thresholds, ensuring that such data is effectively captured to enrich the dataset and improve model robustness.

Herein, the collection ratio information may be directly set by a businessperson or an individual who provides a technology of the present disclosure and may be set based on distribution of the main image data (or the common image data) and the rare image data included in the training data.

In addition, the server 100 may receive target image data transmitted from each vehicle 200 at intervals of a certain time, may include the target image data transmitted from each vehicle 200 in the previously stored training data, may train the learning model to update the learning model, and may distribute the updated learning model to each vehicle 200 again.

Each vehicle 200 may receive the learning model and the target data information distributed from the server 100, may encode an input image captured and obtained by an image capturing means, such as a camera, using an encoder of the learning model to output an encoding vector, may determine a vector similarity between the output encoding vector and the image vectors included in the target data information, may store an image to be collected among input images obtained based on the determined vector similarity and a preset threshold, and may determine and transmit target data from an image collected at intervals of a certain time point to the server 100.

According to an example, each vehicle 200 may determine and transmit an image corresponding to a rare image and an image corresponding to a new type of additional image which is not included in the training data and a target image to the server 100. At this time, each vehicle 200 may determine an input image corresponding to the rare image and the additional image based on target data collection ratio information between the rare image and the additional image.

According to an example, each vehicle 200 may determine target data to be transmitted to the server 100 in a priority with a high vector similarity among the collected input images.

A description will be given below of a detailed operation for a server and a vehicle constituting the system for collecting the target data with reference to FIGS. 2 to 8.

FIG. 2 shows an example of a method for collecting target data according to an example of the present disclosure, which shows an operational flowchart between a server and a vehicle shown in FIG. 1.

Referring to FIG. 2, in S210, the method for collecting the target data according to an example of the present disclosure may be to output encoding vectors of training data using a learning model pre-trained by training data in a server 100.

Herein, the learning model may include an encoder and a decoder. S210 may be to output the encoding vectors for the training data using the encoder.

When the encoding vectors for the training data are output in S210, in S220, first image vectors (or rare image vectors) and second image vectors (or common image vectors) among the output encoding vectors may be extracted.

According to an example, S220 may be to determine a vector similarity between the encoding vectors of the training data to generate a vector similarity table and may a certain number of encoding vectors using a vector similarity of each of pieces of training data, which is stored in the vector similarity table, and a preset threshold. At this time, the vector similarity table may include an average vector similarity obtained by averaging average similarities between the respective vectors and another vector. The corresponding value may represent the clustering of a dataset. In other words, because that the average vector similarity value increases refers to that datasets are similar as a whole, a collection ratio of data, a similarity with a common image vector of which decreases, may increase.

In S220, the processes of extracting the first image vectors and the second image vectors may be different from each other and a threshold for extracting the first image vectors and a threshold for extracting the second image vectors may be the same as or different from each other.

Herein, the first image vectors may refer to vectors for increasing an amount of sparse data in a dataset included in the training data and the second image vectors may refer to vectors for collecting a new type of image data which is not included in the dataset to prevent all the datasets from being similar to each other because there is a problem in which a ratio of sparse data increases, but all the datasets are similar to each other if only an image similar to the rare image vector is obtained. In other words, the second image vectors may be used to collect an image different from the common image as target data.

In addition, S220 may be to extract encoding vectors for a target image to be additionally collected. The target image may be a predetermined image.

The process of extracting the first image vectors and the second image vectors in S220 will be described in detail with reference to FIGS. 3 to 6.

When a certain number of the first image vectors, the second image vectors, and the target image vectors are extracted in S220, in S230, target data information including the extracted image vectors may be transmitted or distributed to each vehicle 200.

According to an example, the target data information may include collection ratio information between the rare image and the additional image and may further include an average vector similarity of each of the first image vectors and an average vector similarity of each of the second image vectors.

In S240, the vehicle 200 may receive and store the target data information transmitted by the server 100 and may determine (or calculate) a vector similarity between the vectors included in the target data information, that is, the first image vectors, the second image vectors, and the target image vectors and encoding vectors of input data, that is, an input image obtained by an image capturing means.

When the vector similarity between the vectors included in the input data and the target data information is determined in S240, in S250, candidate data may be collected from the input data based on the determined vector similarity and a preset threshold.

According to an example, S250 may be to determine a vector similarity between the first image vectors and the target image vectors and the encoding vectors of the input image, when collecting the rare image and the target image from the input image, and collect and store the input image as candidate data of the rare image or the target image, if the determined vector similarity is greater than or equal to the threshold.

According to an example, S250 may be to differently set a threshold for each of the first image vectors, when collecting the rare image from the input image, and collect and store the input image corresponding to the rare image as candidate data based on the encoding vectors of the input image and the differently set threshold of each of the first image vectors.

For example, S250 may be to set a threshold of the rarest image to be smaller than a threshold of another rare image to collect a little more rarest images, which may be to have a difference of a threshold according to the rare image to adjust a collection ratio between rare images.

According to an example, S250 may be to determine a vector similarity between the second image vectors and the encoding vectors of the input image, when collecting a new type of input image, a similarity with the common image of which decreases, that is, an additional image from the input image, determine a weighted mean for the vector similarity by using an average similarity of each of the second image vectors as a weight, and collect an input image, the weighted mean of which is smaller than the threshold, among the input images as candidate data of the additional image.

At this time, S250 may be determine the weighted mean for the vector similarity using Equation 1 below.

$$weighted mean = \frac{1}{n} {\sum }_{i = 1}^{n} {c}_{i} {e}_{i} \qquad [ Equation 1 ]$$

Herein, n may refer to the number of the second image vectors, ci may refer to the average similarity of the ith second image vector, and eᵢ may refer to the vector similarity between the second image vectors and the encoding vectors of the input image.

When the input image corresponding to the rare image, the additional image, and the target image is collected and stored as the candidate data during a preset certain duration in S250, in S260, target data may be determined from the candidate data and the determined target data may be transmitted to the server 100.

According to an example, S260 may be to determine the number of rare images to be collected, the number of additional images, and the number of target images from the stored candidate data, because the number of the pieces of stored candidate data is able to be stored to be greater than the number of pieces of target data to be collected, determine the rare image and the target image in a priority with a high vector similarity with the input image from the stored candidate data, and determine additional data in a priority with a low vector similarity with the input image from the candidate data to determine a certain number of pieces of target data.

FIG. 3 shows an example of a configuration of a system for collecting target data according to another example of the present disclosure. FIG. 4 shows an example of a process of transmitting target data information to each vehicle in a server. FIGS. 5A and 5B show an example of a process of extracting common image vectors and rare image vectors in a system of FIG. 3. FIG. 6 shows an example of a process of collecting target data in a vehicle in a system of FIG. 3.

As shown in FIG. 6, in addition to filtering input data based on vector similarity and thresholds, the vehicle process may allow the similarity thresholds applied to the input data to be adjusted in real time, ensuring that the data collection remains relevant as external factors (e.g., varying environmental conditions such as lighting or weather changes). The vehicle's processor may determine vector similarity on-the-fly, thereby reducing reliance on server-side processing and reducing latency. By integrating a feedback loop with the server, the vehicle may ensure that collected data complements the existing dataset and reduces redundancy.

A description will be given below of a process of determining target data information using FIG. 3 and FIG. 4. A server 100 may train a learning model 110 using a training image stored in an image storage means 140. When an encoder of the pre-trained learning model 110 outputs encoding vectors for each of the training images, the server 100 may store the encoding vectors of the training image and may determine a vector similarity between the stored encoding vectors to generate a vector similarity table 120 (\textcircled{1} and \textcircled{2})

According to an example, the server 100 may determine a cosine similarity between the encoding vectors to determine a vector similarity between training images, may determine an average vector similarity between each of the training images and another training image to include the average vector similarity in the vector similarity table 120.

The server 100 may extract a certain number, for example, an N number of first image vectors and an N number of second image vectors based on the vector similarity stored in the vector similarity table 120 and may extract encoding vectors of a preset or predetermined certain number, for example, an M number of target images (\textcircled{3} and \textcircled{4}).

As shown in FIG. 5A, to ensure the effective extraction of rare image vectors, the sorting process may prioritize encoding vectors with the lowest average similarity to other vectors in the training dataset. This approach may systematically identify underrepresented scenarios that may be useful for enhancing the model's robustness in handling edge cases. The similarity threshold applied during this process may be dynamically adjusted, allowing flexibility to tailor the rarity criteria based on the dataset's distribution and the application's requirements. By excluding highly similar vectors, the system may ensure that only truly unique and rare patterns are preserved. This method may improve the diversity of the training data while reducing redundant processing of common patterns.

According to an example, as shown in FIG. 5A, the server 100 may sort the vector similarity table in a descending order of the average vector similarity, may select an image vector with the highest average vector similarity, and may exclude the image vector, a vector similarity with the selected image vector of which is greater than or equal to a specific value, for example, a threshold (e.g., 0.75 in FIG. 5A), from a second image vector to be extracted. This process is repeatedly performed until a certain number, for example, an N number of vectors are selected. For example, when a vector with an image ID of 152 in FIG. 5A is selected, because the selected vector has a similarity of 0.9 with a vector with an image ID of 87 (510), the vector with the image ID of 87 may be excluded from the second image vector. When a vector with an image ID of 10 is selected, because the selected vector has a similarity of 0.8 with the vector with the image ID of 10, a vector with an image ID of 25 (520) may also be excluded from the second image vector. As this process is repeatedly performed until an N number of second image vectors are selected, the N number of second image vectors may be extracted.

As explained with FIG. 5B, the extraction of common image vectors may ensure the dataset adequately represents frequently encountered scenarios, which are useful for enhancing model accuracy in handling routine tasks. By sorting the encoding vectors in descending order of average similarity, the system may prioritize those that closely resemble the majority of the training data. This step may emphasize patterns that the model is likely to encounter most often in real-world applications. The exclusion of vectors with lower similarity may prevent overrepresentation of less relevant or redundant data, further refining the dataset. This process, coupled with dynamically set similarity thresholds, may enable the system to balance data collection by retaining sufficient diversity while maintaining focus on high-priority patterns that drive generalization in the trained model.

According to an example, as shown in FIG. 5B, the server 100 may sort the vector similarity table in an ascending order of the average vector similarity, may select an image vector with the lowest average vector similarity, and may exclude an image vector, a vector similarity with the selected image vector of which is greater than or equal to the specific value, for example, the threshold (e.g., 0.75 in FIG. 5B), from a first image vector to be extracted. This process is repeatedly performed until a certain number, for example, an N number of vectors are selected. For example, when a vector with an image ID of 35 in FIG. 5B is selected, because the selected vector has a similarity of 0.8 with a vector with an image ID of 23 (530), the vector with the image ID of 23 may be excluded from the first image vector. When a vector with an image ID of 99 is selected, because the selected vector has a similarity of 0.9 with a vector with an image ID of 124 (540), the vector with the image ID of 124 may also be excluded from the first image vector. As this process is repeatedly performed until an N number of first image vectors are selected, the N number of first image vectors may be extracted.

The server 100 may distribute or transmit target data information 130 including the extracted first image vectors, the extracted second image vectors, and target image vectors to a vehicle 200.

A description will be given below of a process of collecting target data using FIGS. 3 and 6. The vehicle 200 may receive a learning model and target data information to be collected from the server 100 and may store the received target data information in a vector storage means 230.

The vehicle 200 may output encoding vectors by means of an encoder of the learning model 210 for an input image obtained in the vehicle 200, may determine a vector similarity between the encoding vectors of the input image and vectors of the target data information stored in the vector storage means 230, that is, the first image vectors, the second image vectors, and the target image vectors by means of a vector similarity computation module 220, and may store an input image corresponding to a rare image, an additional image, and a target image in an image storage means 240 as candidate data, based on the determined vector similarity, a preset threshold, an average vector similarity additionally included in the target data information, collection ratio information between the rare image and the additional image, and the like. This process may be performed during a preset certain duration. The vehicle 200 may determine an input image for being transmitted as target data from the candidate data stored in the image storage means 240 and may transmit the input image to the image storage means 140 of the server 100 at a certain transmission period. Of course, the image storage means 140 of the server 100 may store all the target data collected and transmitted by each vehicle 200, may update a learning model using training data obtained by adding the collected target data, and may distribute the updated learning model to each vehicle 200.

As this process is repeated at intervals of a certain time, inference performance of the learning model may be continuously enhanced.

As such, examples of the present disclosure may collect the target data based on the vector similarity and may provide a data collection pipeline using the vector similarity to easily collect a scene meeting a desired condition.

Furthermore, examples of the present disclosure may select a desired scene from the vehicle without transmission and reception between the vehicle and the server for every scene, thus reducing unnecessary communication cost.

Furthermore, examples of the present disclosure may reduce redundant computation in a vehicle system by using an intermediate network output as it is and may automatize intensive collection for a vulnerable scene in which performance of the network decreases to continuously enhance network inference performance.

Furthermore, examples of the present disclosure may fail to need additional deep learning inference because of using an encoding vector generated in a network inference process in a perception module as it is and may select data from a data collection stage of an autonomous vehicle by means of it.

Furthermore, examples of the present disclosure may intensively obtain a scene meeting a detailed condition, such as a scene, network inference performance of which decreases, a scene, verification of which is required to respond to regulations, or a rare scene in a previously constructed dataset, because it is able to effectively obtain scenes similar to a specific scene.

Furthermore, examples of the present disclosure may be applied in the same manner without correction on implementing several perception modules with different final output forms because of using an encoding vector rather than a final output of the network.

FIG. 7 shows an example of a configuration of a server shown in FIG. 1, which shows an example of a configuration of an example for an apparatus for collecting target data.

Referring to FIG. 7, a server 100 may include a similarity computation device 710, an extraction device 720, an update device 730, and storage 740.

The storage 740 may store all types of data required in the server 100 in a technology of the present disclosure, for example, training data, target data collect at a certain period, a learning model, encoding vectors, a vector similarity table, a target image, a vector similarity computation algorithm, and information about each vehicle.

The similarity computation device 710 may determine a vector similarity between encoding vectors of training data output by the learning model.

The extraction device 720 may generate a vector similarity table based on the vector similarity determined by the similarity computation device 710 and may extract a certain number of encoding vectors using a vector similarity of each of pieces of training data, which is stored in the vector similarity table, and a preset threshold.

According to an example, the extraction device 720 may sort the encoding vectors of the training data in an ascending order on the basis of an average similarity of each of the encoding vectors of the training data to extract a certain number of encoding vectors as first image vectors from an encoding vector with the highest average similarity and may sort the encoding vectors of the training data in a descending order on the basis of an average similarity of each of the encoding vectors of the training data to extract a certain number of encoding vectors as second image vectors from an encoding vector with the lowest average similarity.

The update device 730 may update the learning model using the target data of each vehicle, which is collected from the storage 740 at intervals of a certain time. At this time, the updated learning model may be distributed to each vehicle.

FIG. 8 shows an example of a configuration of a vehicle shown in FIG. 1, which shows an example of a configuration of another example for an apparatus for collecting target data.

Referring to FIG. 8, a vehicle 200 may include a similarity computation device 810, a collection device 820, a determination device 830, and storage 840.

The storage 840 may store all types of data required in the vehicle 200 in a technology of the present disclosure, for example, a learning model, target data information, an input image obtained in the vehicle 200, a vector similarity computation algorithm, encoding vectors, and candidate data corresponding to target data.

The similarity computation device 810 may determine a vector similarity between vectors included in the target data information received from a server, that is, first image vectors, second image vectors, and target image vectors and encoding vectors of input data, that is, an input image obtained by an image capturing means.

The collection device 820 may collect candidate data from the input data based on the vector similarity determined by the similarity computation device 810 and a preset threshold.

According to an example, the collection device 820 may determine a vector similarity between the first image vectors and the target image vectors and the encoding vectors of the input image, when collecting a rare image and a target image from the input image, and may collect the input image as candidate data of the rare image or the target image, if the determined vector similarity is greater than or equal to the threshold.

According to an example, the collection device 820 may differently set a threshold for each of the first image vectors, when collecting the rare image from the input image, and may collect the input image corresponding to the rare image as candidate data based on a threshold of each of the first image vectors which are set to be different from the encoding vectors of the input image.

According to an example, the collection device 820 may determine a vector similarity between the second image vectors and the encoding vectors of the input image, when collecting a new type of input image, a similarity with a common image of which decreases, that is, an additional image from the input image, may determine a weighted mean for the vector similarity by using an average similarity of each of the second image vectors as a weight, and may collect an input image, the weighted mean of which is smaller than the threshold, among the input images as candidate data of the additional image.

The determination device 830 may determine target data from the candidate data collected by the collection device 820 and may transmit the determined target data to the server.

According to an example, the determination device 830 may determine the number of rare images to be collected, the number of additional images, and the number of target images from the candidate data, because the number of the pieces of candidate data is able to be collected to be greater than the number of pieces of target data to be collected, may determine the rare image and the target image in a priority with a high vector similarity with the input image from the candidate data, and may determine additional data in a priority with a low vector similarity with the input image from the candidate data to determine a certain number of pieces of target data.

Although the description thereof is omitted in the server and the vehicle of FIGS. 7 and 8, the server and the vehicle of the present disclosure may include all contents described in the system and the method of FIGS. 1 to 6. This is obvious to those skilled in the technical field of the present disclosure.

FIG. 9 shows an example of a computing system for executing a method for collecting target data according to an example of the present disclosure.

Referring to FIG. 9, the above-mentioned method for collecting the target data according to an example of the present disclosure may be implemented by means of a computing system. A computing system 1000 may include at least one processor 1100, a memory 1300, a user interface input device 1400, a user interface output device 1500, storage 1600, and a network interface 1700, which are connected with each other via a system bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a read only memory (ROM) 1310 and a random access memory (RAM) 1320.

Accordingly, the operations of the method or algorithm described in connection with the examples disclosed in the specification may be directly implemented with a hardware module, a software module, or a combination of the hardware module and the software module, which is executed by the processor 1100. The software module may reside on a storage medium (that is, the memory 1300 and/or the storage 1600) such as a RAM, a flash memory, a ROM, an EPROM, an EEPROM, a register, a hard disc, a removable disk, and a CD-ROM. The exemplary storage medium may be coupled to the processor 1100. The processor 1100 may read out information from the storage medium and may write information in the storage medium. Alternatively, the storage medium may be integrated with the processor 1100. The processor 110 and the storage medium may reside in an application specific integrated circuit (ASIC). The ASIC may reside within a user terminal. In another case, the processor 1100 and the storage medium may reside in the user terminal as separate components.

An example of the present disclosure provides an apparatus and a method for collecting target data to collect the target data based on a vector similarity.

Another example of the present disclosure provides an apparatus and a method for collecting target data to provide a data collection pipeline using a vector similarity to easily collect a scene meeting a desired condition.

Another example of the present disclosure provides an apparatus and a method for collecting target data to select a desired scene from a vehicle without transmission and reception between the vehicle and a server for every scene to reduce unnecessary communication cost.

Another example of the present disclosure provides an apparatus and a method for collecting target data to reduce redundant computation in a vehicle system by using an intermediate network output as it is and automatize intensive collection for a vulnerable scene in which performance of the network decreases to continuously enhance network inference performance.

The technical problems to be solved by the present disclosure are not limited to the aforementioned problems, and any other technical problems not mentioned herein will be clearly understood from the following description by those skilled in the art to which the present disclosure pertains.

According to an example of the present disclosure, an apparatus for collecting target data may include a memory storing computer-executable instructions and at least one processor that accesses the memory and executes the instructions. The at least one processor may receive target data information including vectors of the target data to be collected, may obtain encoding vectors for pieces of input data using a pre-trained learning model, may determine a vector similarity between the encoding vectors obtained for the pieces of input data and the vectors included in the target data information, and may determine the target data among the pieces of input data based on the vector similarity and a preset threshold.

According to an example, the target data information may include at least one of first vectors for collecting rare data included in training data of the learning model, second vectors for collecting additional data which is not included in the training data, or third vectors for collecting data for at least one preset target.

According to an example, the at least one processor may differently set a threshold for each of the first vectors and may collect data corresponding to the first vectors among the pieces of input data based on the differently set threshold of each of the first vectors and the vector similarity.

According to an example, the target data information may include collection ratio information between the rare data and the additional data, when including all the first vectors and the second vectors.

According to an example, the at least one processor may collect data capable of being collected as the target data among the pieces of input data based on the vector similarity and the threshold and may determine the rare data and the additional data based on the collection ratio information in the collected data.

According to an example, the at least one processor may determine a vector similarity between the second vectors and the encoding vectors obtained for the pieces of input data, may determine a weighted mean for the vector similarity by using an average similarity of each of the second vectors included in the target data information as a weight, and may collect input data, the weighted mean of which is smaller than the threshold, as the additional data.

According to an example, the at least one processor may transmit the determined target data to a server at a preset transmission period.

According to another example of the present disclosure, a method for collecting target data may include receiving target data information including vectors of the target data to be collected, obtaining encoding vectors for pieces of input data using a pre-trained learning model, determining a vector similarity between the encoding vectors obtained for the pieces of input data and the vectors included in the target data information, and determining the target data among the pieces of input data based on the vector similarity and a preset threshold.

According to an example, the target data information may include at least one of first vectors for collecting rare data included in training data of the learning model, second vectors for collecting additional data which is not included in the training data, or third vectors for collecting data for at least one preset target.

According to an example, the determining of the target data may include differently setting a threshold for each of the first vectors and collecting data corresponding to the first vectors among the pieces of input data based on the differently set threshold of each of the first vectors and the vector similarity.

According to an example, the target data information may include collection ratio information between the rare data and the additional data, when including all the first vectors and the second vectors.

According to an example, the determining of the target data may include collecting data capable of being collected as the target data among the pieces of input data based on the vector similarity and the threshold and determining the rare data and the additional data based on the collection ratio information in the collected data.

According to an example, the determining of the target data may include determining a vector similarity between the second vectors and the encoding vectors obtained for the pieces of input data, determining a weighted mean for the vector similarity by using an average similarity of each of the second vectors included in the target data information as a weight, and collecting input data, the weighted mean of which is smaller than the threshold, as the additional data.

In addition, the method may further include transmitting the determined target data to a server at a preset transmission period.

According to another example of the present disclosure, a system for collecting target data may include a server that outputs encoding vectors of training data using a pre-trained learning model, extracts vectors for collecting the target data from the encoding vectors, transmits target data information including the extracted vectors and predetermined target vectors and a vehicle that receives the target data information, determines a vector similarity between the vectors included in the target data information and encoding vectors of the learning model for pieces of obtained input data, determines the target data to be collected in the server among the pieces of input data based on the vector similarity and a preset threshold, and transmits the determined target data to the server.

According to an example, the target data information may include first vectors for collecting rare data included in the training data, second vectors for collecting additional data which is not included in the training data, or third vectors for collecting data for at least one preset target. The server may determine the vector similarity between the encoding vectors of the training data to generate a vector similarity table, sorts the encoding vectors of the training data in an ascending order on the basis of an average similarity of each of the encoding vectors of the training data to extract a certain number of encoding vectors as the first vectors from an encoding vector with a highest average similarity, and sorts the encoding vectors of the training data in a descending order on the basis of the average similarity of each of the encoding vectors of the training data to extract a certain number of encoding vectors as the second vectors from an encoding vector with a lowest average similarity.

According to an example, the vehicle may differently set a threshold for each of the first vectors and may collect data corresponding to the first vectors among the pieces of input data based on the vector similarity for the encoding vectors of the learning model for the pieces of input data and the differently set threshold of each of the first vectors.

According to an example, the target data information may include collection ratio information between the rare data and the additional data. The vehicle may collect data capable of being collected as the target data among the pieces of input data based on the vector similarity for the encoding vectors of the learning model for the pieces of input data and the threshold and may determine the rare data and the additional data based on the collection ratio information in the collected data.

According to an example, the vehicle may determine a vector similarity between the second vectors and the encoding vectors of the learning model for the pieces of input data, may determine a weighted mean for the vector similarity by using an average similarity of each of the second vectors included in the target data information as a weight, and may collect input data, the weighted mean of which is smaller than the threshold, as the additional data.

The above-described examples may be implemented with hardware components, software components, and/or a combination of hardware components and software components. For example, the devices, methods, and elements described in the examples of the inventive concept may be implemented by using one or more general-use computers or special-purpose computers, such as a processor, a controller, an arithmetic logic unit (ALU), a digital signal processor, a microcomputer, a field programmable array (FPA), a programmable logic unit (PLU), a microprocessor, or any device which may execute instructions and respond. A processing unit may perform an operating system (OS) or one or software applications running on the OS. Further, the processing unit may access, store, manipulate, process and generate data in response to execution of software. It will be understood by those skilled in the art that although a single processing unit may be shown for convenience of understanding, the processing unit may include a plurality of processing elements and/or a plurality of types of processing elements. For example, the processing unit may include a plurality of processors or one processor and one controller. Also, the processing unit may have a different processing configuration, such as a parallel processor.

Software may include computer programs, codes, instructions or one or more combinations thereof and may configure a processing unit to operate in a desired manner or may independently or collectively instruct the processing unit. Software and/or data may be permanently or temporarily embodied in any type of machine, components, physical equipment, virtual equipment, computer storage media or units or transmitted signal waves so as to be interpreted by the processing unit or to provide instructions or data to the processing unit. Software may be dispersed throughout computer systems connected via networks and may be stored or executed in a dispersion manner. Software and data may be stored in one or more computer-readable storage media.

The methods according to the above-described examples of the inventive concept may be recorded in computer-readable media including program instructions to implement various operations embodied by a computer. The computer-readable media may also include, alone or in combination with the program instructions, data files, data structures, and the like. The program instructions recorded in the media may be designed and configured specially for the examples of the inventive concept or be known and available to those skilled in computer software. Examples of computer-readable media include magnetic media such as hard disks, floppy disks, and magnetic tape; optical media such as compact disc-read only memory (CD-ROM) disks and digital versatile discs (DVDs); magneto-optical media such as floptical disks; and hardware devices that are specially configured to store and perform program instructions, such as read-only memory (ROM), random access memory (RAM), flash memory, and the like. Program instructions include both machine codes, such as produced by a compiler, and higher level codes that may be executed by the computer using an interpreter. The described hardware devices may be configured to act as one or more software modules to perform the operations of the above-described examples of the inventive concept, or vice versa.

Even though the examples are described with reference to restricted drawings, it may be obviously to one skilled in the art that the examples are variously changed or modified based on the above description. For example, adequate effects may be achieved even if the foregoing processes and methods are carried out in different order than described above, and/or the aforementioned components, such as systems, structures, devices, or circuits, are concatenated or coupled in different forms and modes than as described above or be substituted or switched with other components or equivalents.

According to the present disclosure, the apparatus for collecting the target data may collect the target data based on a vector similarity and may provide a data collection pipeline using the vector similarity to easily collect a scene meeting a desired condition.

According to the present disclosure, the apparatus for collecting the target data may select a desired scene from a vehicle without transmission and reception between the vehicle and a server for every scene to reduce unnecessary communication cost.

According to the present disclosure, the apparatus for collecting the target data may reduce redundant computation in a vehicle system by using an intermediate network output as it is and may automatize intensive collection for a vulnerable scene in which performance of the network decreases to continuously enhance network inference performance.

The effects that are achieved through the present disclosure may not be limited to the effects described above, and other advantages not described above may be more clearly understood from the following detailed description by those skilled in the art to which the present disclosure pertains.

Hereinabove, although the present disclosure has been described with reference to examples and the accompanying drawings, the present disclosure is not limited thereto, but may be variously modified and altered by those skilled in the art to which the present disclosure pertains without departing from the spirit and scope of the present disclosure claimed in the following claims. Therefore, examples disclosed in the present disclosure are not intended to limit the technical spirit of the present disclosure, and the scope of the technical spirit of the present disclosure is not limited by such an example. The scope of the present disclosure should be construed on the basis of the accompanying claims, and all the technical ideas within the scope equivalent to the claims should be included in the scope of the present disclosure.

What is claimed:

1. An apparatus for controlling autonomous driving of a vehicle, the apparatus comprising:
at least one processor; and
a memory storing instructions that, when executed by the at least one processor, are configured to cause the apparatus to:
receive target data information, wherein the target data information comprises vectors of target data;
obtain, using a pre-trained learning model, encoding vectors from pieces of input data;
determine a vector similarity between the encoding vectors and the vectors of the target data; and
determine, based on the vector similarity and a preset similarity threshold, the target data among the pieces of input data.

2. The apparatus of claim 1, wherein the vectors of the target data comprise at least one of:
first vectors for obtaining rare data included in training data of the pre-trained learning model, wherein the rare data corresponds to data associated with images having lower average similarities than other images,
second vectors for obtaining additional data which is not included in the training data, or
third vectors for obtaining data for at least one preset target.

3. The apparatus of claim 2, wherein the instructions, when executed by the at least one processor, are configured to cause the apparatus to:
differently set a similarity threshold for each of the first vectors; and
obtain, based on the vector similarity and the differently set similarity threshold of each of the first vectors, data corresponding to the first vectors among the pieces of input data.

4. The apparatus of claim 2, wherein the target data information indicates the first vectors and the second vectors, and wherein the target data information comprises collection ratio information between the rare data and the additional data.

5. The apparatus of claim 4, wherein the instructions, when executed by the at least one processor, are configured to cause the apparatus to:
obtain, based on the vector similarity and the preset similarity threshold, pieces of collected data among the pieces of input data as the target data; and
classify, based on the collection ratio information, the obtained pieces of collected data into the rare data and the additional data.

6. The apparatus of claim 2, wherein the instructions, when executed by the at least one processor, are configured to cause the apparatus to:
determine a vector similarity between the second vectors and the encoding vectors;
determine a weighted mean of vector similarities by using an average similarity of each of the second vectors as a weight; and
obtain input data as the additional data, wherein a weighted mean of vector similarities for the input data is smaller than the preset similarity threshold.

7. The apparatus of claim 1, wherein the instructions, when executed by the at least one processor, are configured to cause the apparatus to:
transmit the determined target data to a server at a preset transmission period.

8. A method performed by an apparatus for controlling autonomous driving of a vehicle, the method comprising:
receiving target data information, wherein the target data information comprises vectors of the target data;
obtaining, using a pre-trained learning model, encoding vectors from pieces of input data;
determining a vector similarity between the encoding vectors and the vectors of the target data;
determining, based on the vector similarity and a preset similarity threshold, the target data among the pieces of input data;
outputting, based on the determined target data, a signal; and
controlling, based on the signal, autonomous driving of the vehicle.

9. The method of claim 8, wherein the vectors of the target data comprise at least one of:
first vectors for obtaining rare data included in training data of the pre-trained learning model, wherein the rare data corresponds to data associated with images having lower average similarities than other images,
second vectors for obtaining additional data which is not included in the training data, or
third vectors for obtaining data for at least one preset target.

10. The method of claim 9, wherein the determining the target data comprises:
differently setting a similarity threshold for each of the first vectors; and
obtaining, based on the vector similarity and the differently set similarity threshold of each of the first vectors, data corresponding to the first vectors among the pieces of input data.

11. The method of claim 9, wherein the target data information indicates the first vectors and the second vectors, and wherein the target data information comprises collection ratio information between the rare data and the additional data.

12. The method of claim 11, wherein the determining the target data comprises:
obtaining, based on the vector similarity and the preset similarity threshold, pieces of collected data among the pieces of input data as the target data; and
classifying, based on the collection ratio information, the obtained pieces of collected data into the rare data and the additional data.

13. The method of claim 9, wherein the determining the target data comprises:
determining a vector similarity between the second vectors and the encoding vectors;
determining a weighted mean of vector similarities by using an average similarity of each of the second vectors as a weight; and
obtaining input data as the additional data, wherein a weighted mean of vector similarities for the input data is smaller than the preset similarity threshold.

14. The method of claim 8, further comprising:
transmitting the determined target data to a server at a preset transmission period.

15. A system for controlling autonomous driving of at least one vehicle, the system comprising:
a server configured to:
output, using a pre-trained learning model, encoding vectors of training data,
extract vectors for obtaining target data from the encoding vectors, and transmit target data information, wherein the target data information comprises the extracted vectors and predetermined target vectors; and
a vehicle configured to:
receive the target data information from the server,
determine, for pieces of obtained input data, a vector similarity between the predetermined target vectors and the encoding vectors,
determine, based on the vector similarity and a preset similarity threshold, target data to be obtained by the server among the pieces of input data, and
transmit the determined target data to the server.

16. The system of claim 15, wherein the predetermined target vectors comprise at least one of:
first vectors for obtaining rare data included in the training data, wherein the rare data corresponds to data associated with images having lower average similarities than other images,
second vectors for obtaining additional data which is not included in the training data, or
third vectors for obtaining data for at least one preset target, and wherein the server is configured to:
determine vector similarities among the encoding vectors of the training data to generate a vector similarity table;
sort, based on an average similarity of each of the encoding vectors of the training data, the encoding vectors in an ascending order to extract a first predetermined number of encoding vectors with a highest average similarity as the first vectors; and
sort, based on the average similarity, the encoding vectors in a descending to extract a second predetermined number of encoding vectors with a lowest average similarity as the second vectors.

17. The system of claim 16, wherein the vehicle is configured to:
differently set a similarity threshold for each of the first vectors, and
based on the vector similarity and the differently set thresholds for each of the first vectors, obtain data corresponding to the first vectors among the pieces of input data.

18. The system of claim 16, wherein the target data information comprises collection ratio information between the rare data and the additional data, and
wherein the vehicle is configured to:
obtain, based on the vector similarity and the preset similarity threshold, pieces of collected data among the pieces of input data as the target data; and
classify, based on the collection ratio information, the obtained pieces of collected data into the rare data and the additional data.

19. The system of claim 16, wherein the vehicle is configured to:
determine a vector similarity between the second vectors and the encoding vectors;
determine a weighted mean of vector similarities by using an average similarity of each of the second vectors as a weight; and
obtain input data as the additional data, wherein a weighted mean of vector similarities for the input data is smaller than the preset similarity threshold.

20. The system of claim 15, wherein the vehicle is configured to:
transmit the determined target data to the server at a preset transmission period.
